(19) United States
(12) Patent Application Publication
(10) Pub. No.: US 2010/0182638 A1
(43) Pub. Date: Jul. 22, 2010

(54) RECORDING MEDIUM AND INFORMATION PROCESSOR

(75) Inventors: Jun KIMURA, Tokyo (JP); Kazuhiro Kurabayashi, Tokyo (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/652,066

(22) Filed: Jan. 5, 2010

(30) Foreign Application Priority Data
Jan. 19, 2009 (JP) 2009-009089
Apr. 28, 2009 (JP) 2009-109886

(51) Int. Cl. G06F 3/12

(52) U.S. Cl. 358/1.15

(57) ABSTRACT

A computer-readable recording medium is disclosed on which a program is recorded for causing a computer to execute a method for outputting printing data from a printer driver to an output destination. The method includes displaying, while the printer driver is inactive, a change screen for changing the output destination from a first output destination preset in a communication control part by a display part of an output destination changing part; transmitting a change notification including identification information indicating a second output destination input through the change screen to the communication control part by a notification part of the output destination changing part; and changing the output destination from the preset first output destination to the second output destination by the communication control part in response to receiving the change notification.

### CROSS-REFERENCE TO RELATED APPLICATION

The present application is based upon and claims the benefit of priority of Japanese Patent Application No. 2009-009089, filed on Jan. 19, 2009, and Japanese Patent Application No. 2009-109886, filed on Apr. 28, 2009, the entire contents of which are incorporated herein by reference.

### BACKGROUND OF THE INVENTION

1. Field of the Invention

The present invention relates to a recording medium on which a program is recorded for transmitting printing data to an output destination, and to an information processor that transmits printing data to an output destination.

2. Description of the Related Art

In recent years, there has been a demand for a printing system that enables users who move between branches or floors using notebook personal computers (PCs) or the like to freely select a printer for outputting. In order to meet this demand, some printer driver techniques cause a screen for specifying a printer for outputting to be displayed so as to allow printers installed at respective points to be selected with a single printer driver. That is, printer drivers have been already known that can easily change the output destination by displaying a screen for specifying the output destination and allowing its selection every time printing is performed. (Hereinafter, such printer drivers may be referred to as “mobile drivers.”)

For example, Japanese Patent No. 3484816 describes a technique for facilitating switching of printers on a network by causing a desired printer to be selected from multiple printers on the network, and inputting a predetermined setup and making a printing instruction request through a printing instruction operations panel.

### SUMMARY OF THE INVENTION

According to an aspect of the present invention, a computer-readable recording medium is provided on which a program is recorded for causing a computer to execute a method for outputting printing data from a printer driver to an output destination, where the method includes displaying, while the printer driver is inactive, a change screen for changing the output destination from a first output destination preset in a communication control part by a display part of an output destination changing part; transmitting a change notification including identification information indicating a second output destination input through the change screen to the communication control part by a notification part of the output destination changing part; and changing the output destination from the preset first output destination to the second output destination by the communication control part in response to receiving the change notification.

According to one aspect of the present invention, an information processor includes a communication control part configured to output printing data from a printer driver installed in the information processor to an output destination; and an output destination changing part, the output destination changing part including a display part configured to display, while the printer driver is inactive, a change screen for changing the output destination from a first output destination preset in the communication control part; and a notification part configured to transmit a change notification including identification information indicating a second output destination input through the change screen to the communication control part, wherein the communication control part is configured to change the output destination from the preset first output destination to the second output destination in response to receiving the change notification from the notification part.

The object and advantages of the embodiments will be realized and attained by means of the elements and combinations particularly pointed out in the claims.

It is to be understood that both the foregoing general description and the following detailed description are exemplary and explanatory and not restrictive of the invention as claimed.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating a schematic hardware configuration of an information processor according to a first embodiment of the present invention;

FIG. 2 is a concept diagram illustrating a function of the information processor according to the first embodiment of the present invention;

FIG. 3 is a block diagram illustrating a software configuration of the information processor according to the first embodiment of the present invention;

FIG. 4 is a block diagram illustrating a functional configuration of the information processor according to the first embodiment of the present invention;

FIG. 5 is a diagram illustrating an output destination change screen according to the first embodiment of the present invention;

FIG. 6 is a sequence diagram illustrating an output destination changing process by the information processor according to the first embodiment of the present invention;

FIG. 7 is a sequence diagram illustrating an output destination usage determining process according to the first embodiment of the present invention;

FIG. 8 is a sequence diagram illustrating an output destination communication determining process according to the first embodiment of the present invention;

FIG. 9 is a sequence diagram illustrating another output destination changing process according to the first embodiment of the present invention;

FIG. 10 is a concept diagram illustrating a function of the information processor according to a second embodiment of the present invention;

FIG. 11 is a block diagram illustrating a functional configuration of the information processor according to the second embodiment of the present invention;

FIG. 12 illustrates a driver list according to the second embodiment of the present invention;

FIG. 13 is a flowchart illustrating a port changing process at the time of installation of an output destination changing application according to the second embodiment of the present invention; and

FIG. 14 is a flowchart illustrating a port changing process at the time of installation of a printer driver according to the second embodiment of the present invention.

### DETAILED DESCRIPTION OF THE PREFERRED EMBODIMENTS

According to the conventional techniques, such as the one described in Japanese Patent No. 3484816 mentioned above, when using a mobile driver, the operational restrictions of the printer driver make it necessary for a user to select an output destination printer at every time of printing. Therefore, there is a problem in that this bothers users who do not change the output destination frequently.

According to one aspect of the present invention, there is provided a recording medium on which a program is recorded that reduces trouble on the part of a user at the time of using a mobile driver by avoiding the operational restrictions of the printer driver and making it possible to perform an operation for changing the output destination when it is desired to change the output destination.

According to one aspect of the present invention, an information processor is provided that reduces trouble on the part of a user at the time of using a mobile driver by avoiding the operational restrictions of the printer driver and making it possible to perform an operation for changing the output destination when it is desired to change the output destination.

A description is given below, with reference to the accompanying drawings, of embodiments of the present invention.

### First Embodiment

First, a description is given of a hardware configuration of an information processor according to a first embodiment of the present invention.

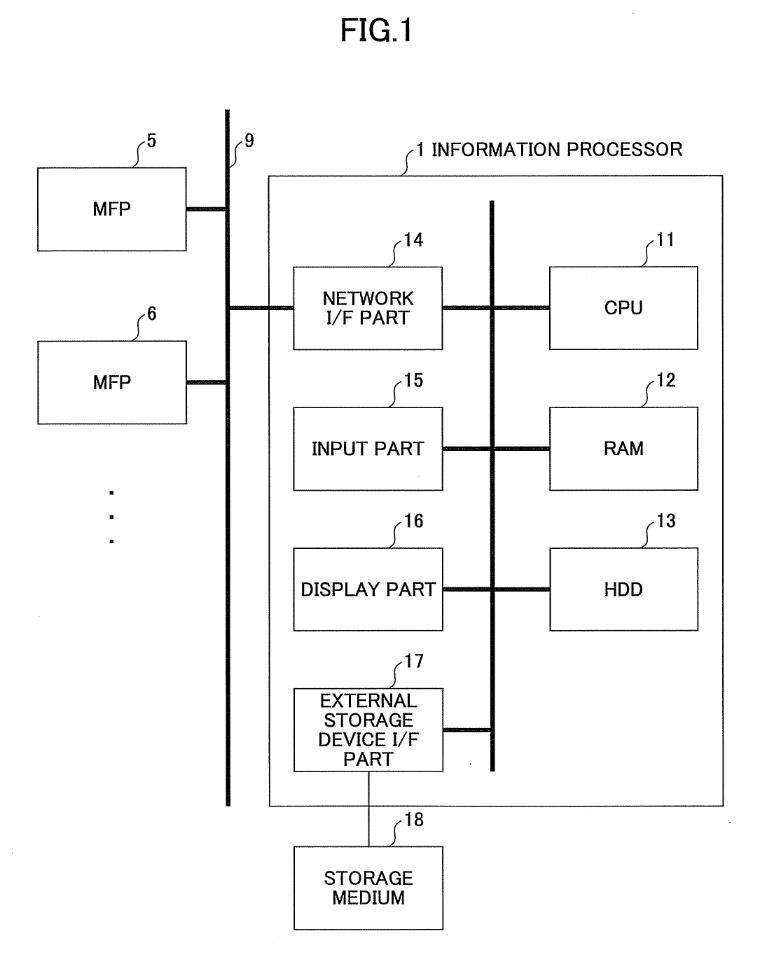

FIG. 1 is a block diagram illustrating a schematic hardware configuration of an information processor 1 according to the first embodiment of the present invention.

As illustrated in FIG. 1, the information processor 1 of this embodiment may be connected to one or more multifunction peripherals (MEPs) (for example, image forming apparatuses) such as an MFP 5 and an MFP 6 through a network 9 such as a local area network (LAN) or wide area network (WAN) constructed with wire and/or wireless (radio) data transmission channels (for example, Ethernet [registered trademark]). The information processor 1 includes a central processing unit (CPU) 11, a random access memory (RAM) 12, a hard disk drive (HDD) 13, a network interface (I/F) part 14, an input part 15, a display part 16, and an external storage device interface (I/F) 17.

The CPU 11 controls devices, and performs operations on and processes data in a computer. The CPU 11, which is a processor that executes a program stored in the RAM 12, receives data from an input device or a storage device, performs operations on and processes the received data, and thereafter outputs the data to an output device or a storage device.

The RAM 12 is a storage device that stores or temporarily retains programs executed by the CPU 11, such as an operating system (OS), which is basic software, and application software, and data.

The HDD 13 is a storage device that stores data related to application software.

The network I/F part 14 is an interface between the information processor 1 and the MFPs 5 and 6 having a communication function and connected to the information processor 1 through the network 9.

The input part 15 and the display part 16, which include key switches (hard keys) and a liquid crystal display (LCD) having a touch panel function (including software keys of a graphical user interface [GUI]), are a display and/or input device that serves as a user interface (UI) when the functions of the information processor 1 are used.

The external storage device I/F part 17 is an interface between the information processor 1 and a storage medium (recording medium) 18 (such as a flash memory) connected to the information processor 1 through a data transmission channel such as a universal serial bus (USB).

A predetermined program may be stored in the storage medium 18. The program stored in the storage medium 18 may be installed in the information processor 1 through the external storage device I/F part 17. The installed program is executable by the information processor 1.

The information processor 1 is, for example, a personal computer (PC). In the case illustrated in FIG. 1, one information processor and two MFPs are connected. According to this embodiment, however, the number of information processors connected and the number of MFPs connected are not limited to these numbers.

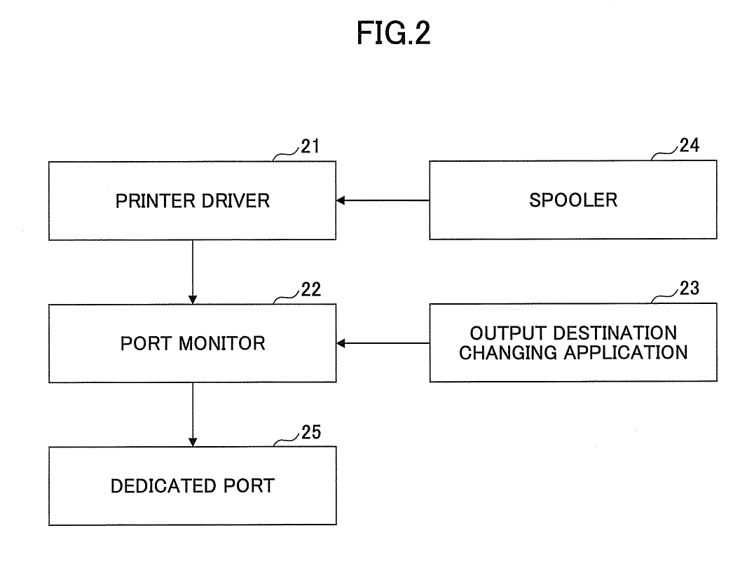

FIG. 2 is a concept diagram illustrating a function of the information processor 1 according to the first embodiment. An overview of the function is as follows. The printing data created with a printer driver 21 are forwarded to a port through a port monitor 22. The printing data forwarded to the port are transmitted to the output destination address (that is, printer) set for the port. A spooler 24 determines which port the printing data are to be transmitted from. The spooler 24 also changes the port.

According to the first embodiment, as illustrated in FIG. 2, once an output destination changing application 23 is installed, it is possible to change the output destination address of a corresponding dedicated port 25. For example, in the case where multiple output destination addresses are set for the dedicated port 25, the output destination changing application 23 makes it possible to suitably set or change the output destination address to which the printing data are to be transmitted even if the printer driver 21 has not been started (activated). However, the output destination changing application 23 is prevented from changing the output destination addresses of ports other than the dedicated port 25. A detailed description is given below of the printer driver 21, the port monitor 22, and the output destination changing application 23.

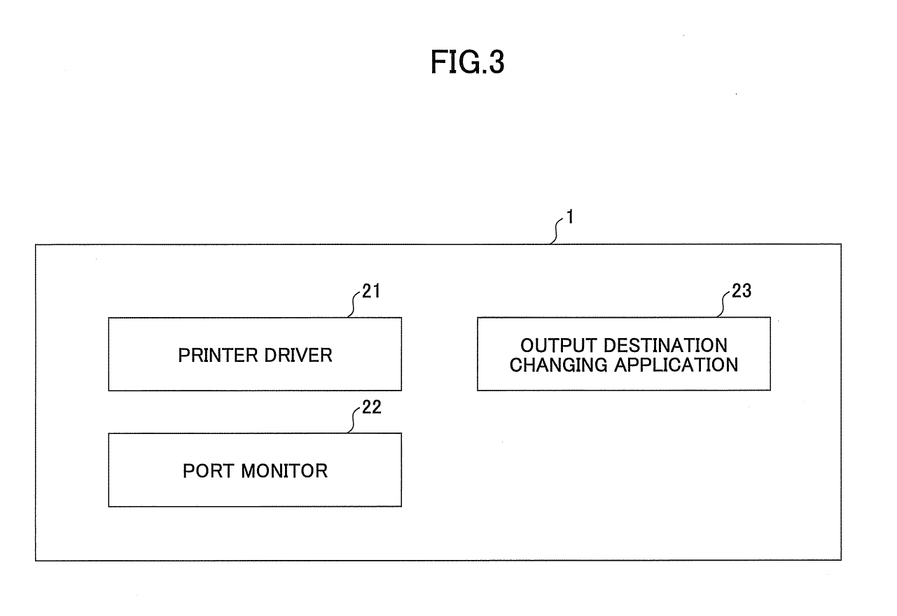

FIG. 3 is a block diagram illustrating a software configuration of the information processor 1 according to the first embodiment. As illustrated in FIG. 3, the information processor 1 includes the printer driver 21, the port monitor 22, and the output destination changing application 23.

The printer driver 21 converts the image information generated by an application into a page description language understandable by an MFP in printing the image information. The printer driver 21 outputs the converted information in the page description language to the port monitor 22. It is assumed that the printer driver 21 is a mobile driver, or a printer driver for performing printing with an office printer from a mobile environment such as a notebook PC.

The port monitor 22 outputs the converted information described in the page description language output from the printer driver 21 to a preset MFP (or a preset output destination) through Ethernet (registered trademark) or a USB. Here, it is assumed that the information processor 1 is connected to Ethernet (registered trademark). Examples of the port monitor 22 include a port monitor called Standard TCP/IP Port, which is for Windows (registered trademark) network printers.

The output destination changing application 23 transmits a notification for changing the output destination set in the port monitor 22 to the port monitor 22 based on a user's instruction or the like. In the notification, the xcv command specified by Windows (registered trademark) is used in order to replace the address of the set output destination (such as the IP address in TCP/IP) with the address of the output destination newly selected or input by the user. The xcv command is used to externally change the address of the output destination.

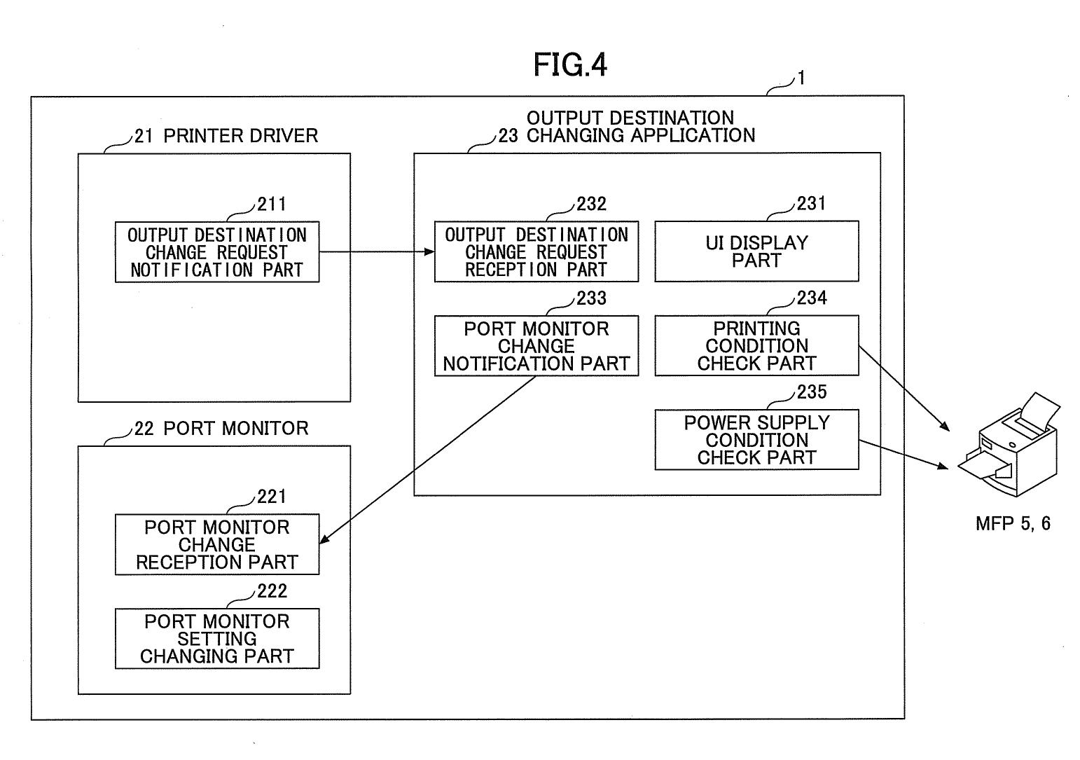

FIG. 4 is a block diagram illustrating a functional configuration of the information processor 1 according to the first embodiment.

Referring to FIG. 4, the printer driver 21 includes an output destination change request notification part 211; the port monitor 22 includes a port monitor change reception part 221 and a port monitor setting changing part 222; and the output destination changing application 23 includes a UI display part 231, an output destination change request reception part 232, a port monitor change notification part 233, a printing condition check (determination) part 234, and a power supply condition check (determination) part 235.

A description is given below of the functions of the printer driver 21, the port monitor 22, and the output destination changing application 23 in this order.

The output destination change request notification part 211 of the printer driver 21 makes (transmits) an output destination change request (a request to change the output destination) to the output destination changing application 23 in response to detecting the pressing of a PRINT button by a user. The output destination change request is made using a remote procedure call (RPC).

Next, the port monitor change reception part 221 of the port monitor 22 (a communication control part) receives an output destination change request from the port monitor change notification part 233 described below. At this point, the port monitor change reception part 221 also obtains information on the requested output destination with which the (presently) set output destination is to be replaced. The information on the requested output destination includes, for example, the address of the requested output destination.

The port monitor setting changing part 222 changes the output destination from the set one to the one received by the port monitor change reception part 221. As a result, the output destination of print jobs is changed (or updated) after completion of the setting change of the output destination.

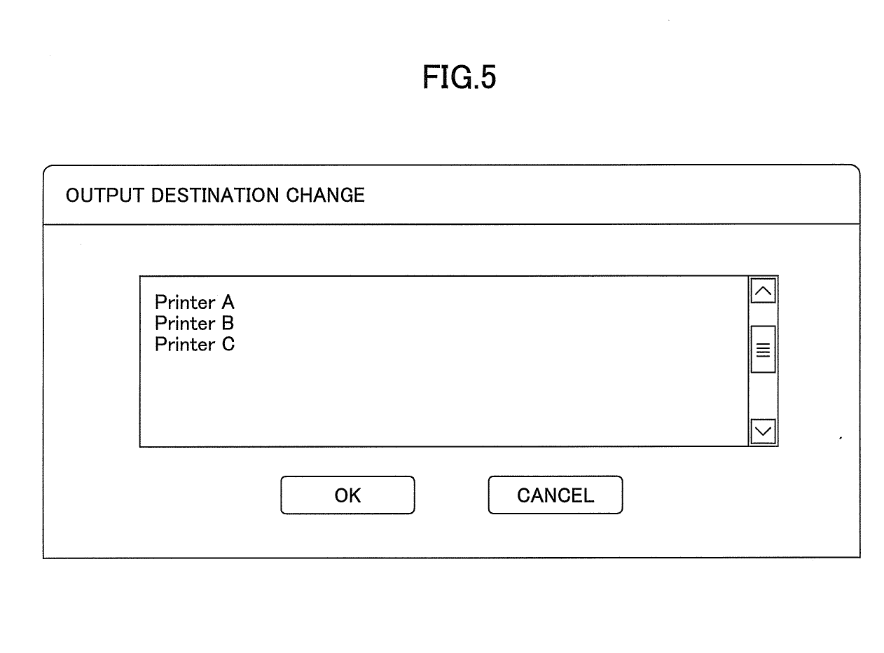

Next, the UI display part 231 of the output destination changing application 23 (an output destination change part) displays an output destination change screen for causing a user to select or input an output destination on the display part 16 (FIG. 1) in response to a user's instruction even if the printer driver 21 is not started. FIG. 5 is a diagram illustrating an example of the output destination change screen. Referring to FIG. 5, a user is allowed to select one of “Printer A,” “Printer B,” and “Printer C.” Further, the UI display part 231 outputs identification information indicating the selected MFP to the port monitor change notification part 233.

The output destination change screen may also be configured to allow a user to enter (input) the address of an MFP directly, or to retrieve connected MFPs and allow a user to select one from the retrieved connected MFPs (retrieval results). Further, the UI display part 231 displays the output destination change screen in response to receiving an output destination change screen display request (a request to display the output destination change screen) from the output destination change request reception part 232 described below. Further, as an additional function, the UI display part 231 displays an error message in response to receiving an error notification from the printing condition check part 234 or the power supply condition check part 235.

Referring back to FIG. 4, the output destination change request reception part 232 makes an output destination change screen display request to the UI display part 231 in response to receiving an output destination change request from the output destination change request notification part 211.

The port monitor change notification part 233 notifies the port monitor 22 of an address corresponding to the identification information obtained from the UI display part 231, using the xcv command specified by Windows (registered trademark). Further, the port monitor change notification part 233 retains information on the correspondence between the identification information of the output destination and the address.

The printing condition check part 234 determines whether the output destination set in the port monitor 22 is in use. The printing condition check part 234 notifies the UI display part of an error in response to determining that printing (imaging) of printing data is in process at the output destination (the output destination is in use). The printing condition check part 234 notifies the port monitor change notification part 233 that the output destination is not in use in response to determining that the output destination is not in use.

Next, a description is given of a determination as to whether the output destination is performing printing (in a printing process). First, the printing condition check part 234 communicates with an MFP in order to obtain a list of jobs that are being printed in the MFP. If the result of the communication shows that there is no job that is being printed, the printing condition check part 234 determines that the output destination is “not performing printing.” On the other hand, if the result of the communication shows that there is one or more jobs that are being printed, the printing condition check part 234 determines that the output destination is “performing printing.”

This makes it possible to prevent inconvenience such as transmission of printing data to another MFP during their printing (imaging) in the output destination due to occurrence of the operation of changing the output destination during the printing.

The power supply condition check part 235 determines whether it is possible to communicate with the output destination set in the port monitor 22. The communication with the output destination may be prevented if the output destination MFP is turned OFF or the network 9 is interrupted. The power supply condition check part 235 notifies the UI display part 231 of an error in response to determining that it is not possible to communicate with the output destination. The power supply condition check part 235 notifies the port monitor change notification part 233 that it is possible to communicate with the output destination in response to determining that it is possible to communicate with the output destination.

This prevents inconvenience such as a user being prevented from performing printing immediately after changing the output destination.

Whether it is possible to communicate with an MFP is determined by checking the power supply condition of the MFP by performing bidirectional communications between the information processor 1 and the MFP and making a request to obtain the apparatus information of the MFP by the information processor 1.

Here, in the case where the printing condition check part 234 and/or the power supply condition check part 235 performs checking, the port monitor change notification part 233 transmits a change notification to the port monitor 22 in response to receiving the above-described notification from the printing condition check part 234 and/or the power supply condition check part 235. This makes it possible to change the output destination with more reliability and safety.

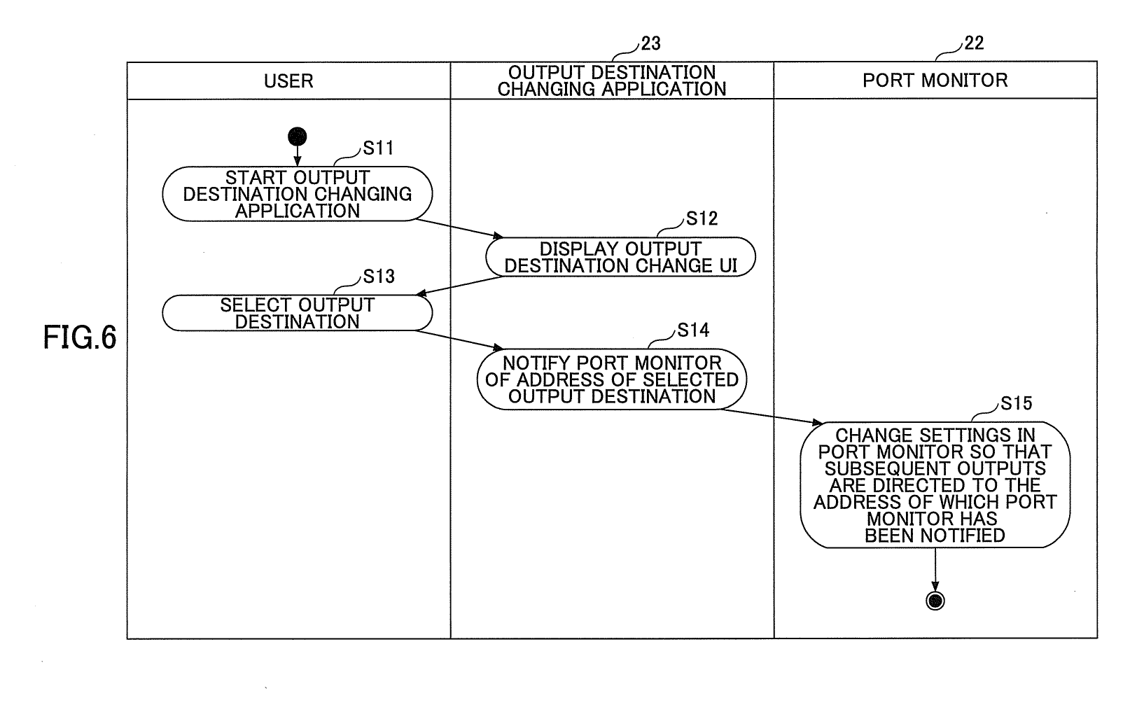

FIG. 6 is a sequence diagram illustrating an output destination changing process by the information processor 1.

Referring to FIG. 6, in step S11, a user starts the output destination changing application 23.

In step S12, the output destination changing application 23 (the UI display part 231) displays an output destination change screen on the display part 16 in response to receiving an instruction from the user.

In step S13, the user selects the output destination of printing data. For example, in the case of the output destination change screen illustrated in FIG. 5, the user selects one of output destinations and presses an OK button. This allows the output destination changing application 23 to identify the selected output destination.

In step S14, the output destination changing application 23 (the port monitor change notification part 233) notifies the port monitor 22 of the address of the output destination selected by the user, using an xcv command.

In step S15, the port monitor 22 replaces the address of the set output destination with the address of the output destination of which the port monitor 22 has been notified by the output destination changing application 23 through the xcv command. As a result, the changed output destination serves as an output destination for and after the next time.

As a result of the above, it is possible to avoid the operational restrictions of a printer driver and to change the output destination when it is desired to change the output destination instead of changing the output destination every time printing is performed. That is, a user is allowed to change the output destination of printing data at a desired time independently (or irrespective) of a printing process.

Next, a description is given of the case where the output destination changing application 23 determines whether a predetermined condition is met, and notifies the port monitor 22 of the address of the output destination in response to determining that the predetermined condition is met.

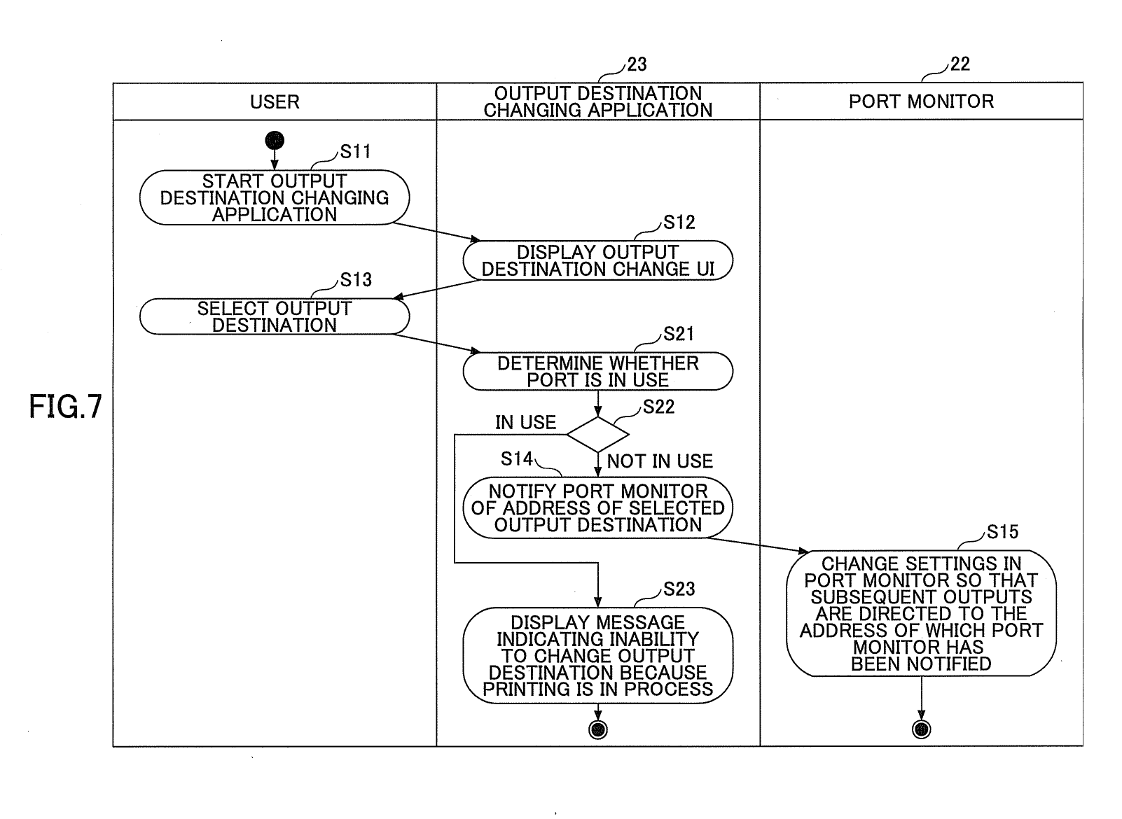

FIG. 7 is a sequence diagram illustrating an output destination usage determining process according to the first embodiment. In the process illustrated in FIG. 7, the same steps as those of FIG. 6 are referred to by the same step numbers, and a description thereof is omitted.

Referring to FIG. 7, in step S21, the output destination changing application 23 (the printing condition check part 234 [FIG. 4]) determines whether printing is in process in the MFP set for (correlated with) the dedicated port 25. If the output destination changing application 23 determines in step S22 that printing is in process in the MFP set in the port monitor 22 (the MFP is in use), the process proceeds to step S23. If the output destination changing application 23 determines in step S22 that the MFP set in the port monitor 22 is not in use, the process proceeds to step S14. The processing in and after step S14 is the same as described above with reference to FIG. 6.

In step S23, the UI display part 231 (FIG. 4) indicates that it is not possible to change the output destination (MFP) on the display part 16 (FIG. 1) in response to receiving an error notification (a notification to the effect that the MFP is in use) from the printing condition check part 234.

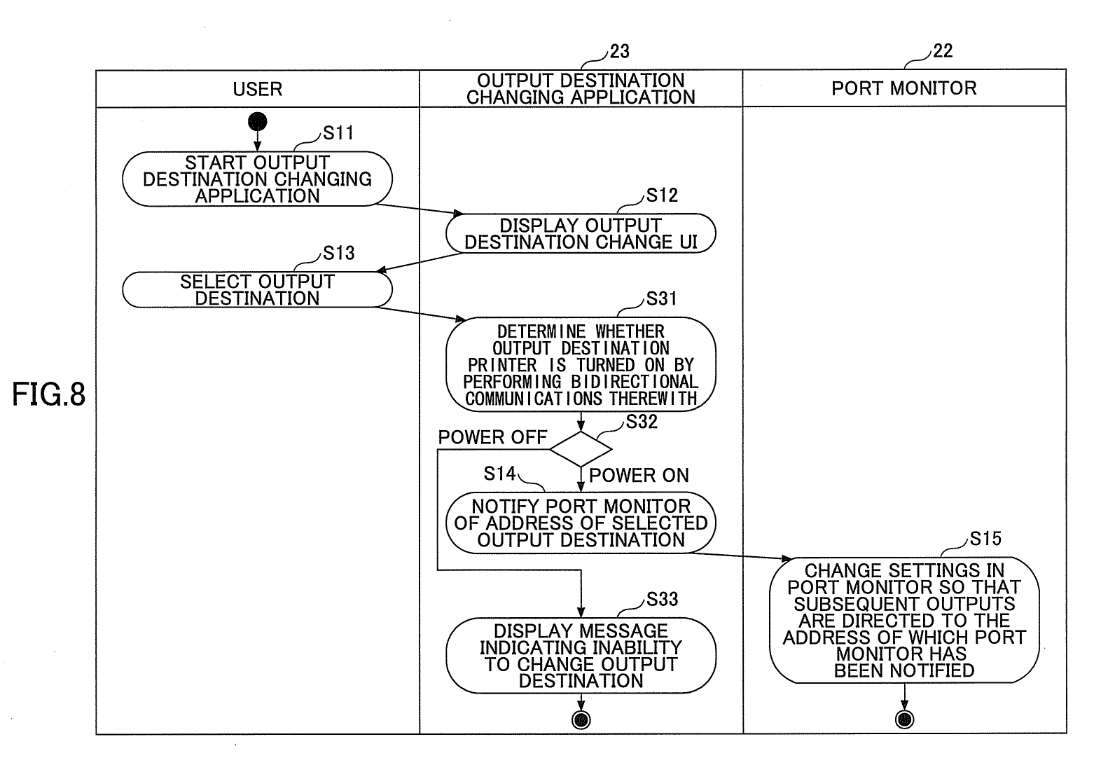

FIG. 8 is a sequence diagram illustrating an output destination communication determining process according to the first embodiment. In FIG. 8, the same steps as those of FIG. 6 are referred to by the same step numbers, and a description thereof is omitted.

Referring to FIG. 8, in step S31, the output destination changing application 23 (the power supply condition check part 235 [FIG. 4]) performs bidirectional communications with the MFP set for (correlated with) the dedicated port 25 to determine whether the MFP is turned ON. If the output destination changing application 23 determines in step S32 that the MFP is turned OFF, the process proceeds to step S33. If the output destination changing application 23 determines in step S32 that the MFP is turned ON, the process proceeds to step S14. The processing in and after step S14 is the same as described above with reference to FIG. 6.

In step S33, the UI display part 231 (FIG. 4) indicates that it is not possible to change the output destination (MFP) on the display part 16 (FIG. 1) in response to receiving an error notification (a notification to the effect that the MFP is turned OFF) from the power supply condition check part 235.

Thus, according to the first embodiment, installation of the printing condition check part 234 makes it possible to prevent inconvenience such as transmission of printing data to another MFP during their being printing (imaging) in the output destination MFP due to occurrence of the operation of changing the output destination during the printing. Further, installation of the power supply condition check part 235 makes it possible to prevent inconvenience such as a user being prevented from performing printing immediately after changing the output destination. The printing condition check part 234 and the power supply condition check part 235 are optional, and it is possible to provide only one, both, or neither of the printing condition check part 234 and the power supply condition check part 235.

The printing condition check part 234 described above reports an error in response to the output destination MFP being in use. Alternatively, instead of reporting an error, the printing condition check part 234 may wait for completion of the printing by the output destination and transmit a change instruction to the port monitor change notification part 233 after completion of the printing.

Further, the power supply condition check part 235 described above reports an error in response to the output destination MFP being prevented from communicating. Alternatively, instead of reporting an error, the power supply condition check part 235 may wait for the output destination MFP to become able to communicate and transmit a change instruction to the port monitor change notification part 233 after the output destination MFP becomes able to communicate.

Next, a description is given of the process of instructing the output destination change application 23 to display an output destination change screen by the printer driver 21 in order to perform a conventional operation instead of changing the output destination of printing data at a desired time by a user.

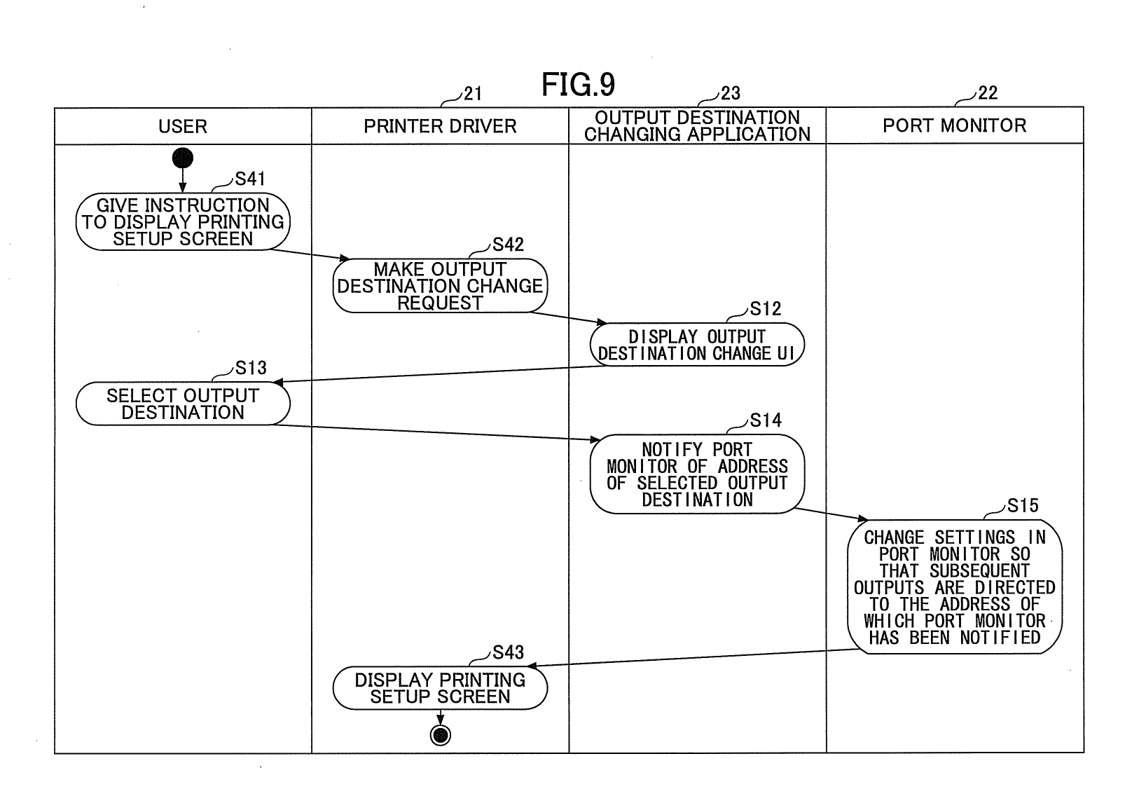

FIG. 9 is a sequence diagram illustrating another output destination changing process according to the first embodiment. In the process illustrated in FIG. 9 as well, the same steps as those of FIG. 6 are referred to by the same step numbers, and description thereof is omitted.

Referring to FIG. 9, in step S41, when a user presses a PRINT button, the printer driver 21 is notified of the pressing of the PRINT button.

In step S42, in response to being notified of the pressing of the PRINT button by the user, the printer driver 21 makes (transmits) an output destination change request (a request to change the output destination) to the output destination changing application 23. The output destination change request is made using a remote procedure call (RPC).

The processing in and after step S12 is as described above, and when the output destination is changed in step S15, in step S43, the printer driver 21 displays a printing setup screen.

As a result, the user is allowed to change the output destination at the time of printing as is conventionally done. In the case illustrated in FIG. 9, the request of step S42 is made to the output destination changing application 23 before displaying a printing setup screen. However, the making of the request of step S42 is not limited to this timing, and the request of step S42 may be made to the output destination changing application 23 before actual transmission of printing data after the user presses a printing execution button.

Thus, according to the first embodiment, a user is allowed to change the output destination at the time of performing printing even in the case of changing the output destination with an application independent of a printer driver.

### Second Embodiment

Next, a description is given of a function of the information processor 1 according to a second embodiment of the present invention. According to the second embodiment, the output destination change application changes the port to be used for transmission of printing data using a spooler. As a result, when the output destination changing application is installed or a printer driver is newly installed, a user does not have to set the dedicated port of the output destination changing application as the port of the printer driver, and the dedicated port of the output destination changing application can be set automatically as the port of the printer driver.

According to the second embodiment, the printer driver is a universal driver that supports multiple types of machines or a mobile driver.

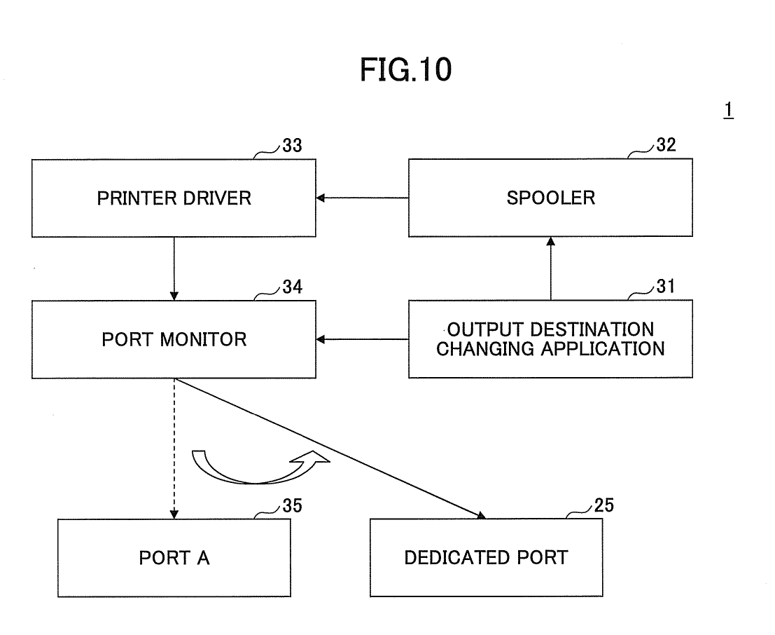

FIG. 10 is a concept diagram illustrating a function of the information processor 1 according to the second embodiment. According to the second embodiment, as illustrated in FIG. 10, an output destination changing application 31 can change the port to be used for transmission of printing data using a spooler 32. That is, even if a printer driver 33 uses a port A 35 before installation of the output destination changing application 31, it is possible to change (switch) automatically from the port A 35 to the dedicated port 25 after the installation.

Further, even if the newly installed printer driver 33 uses the port A 35 as a default setup, the output destination changing application 31 makes it possible to change (switch) automatically from the port A 35 to the dedicated port 25.

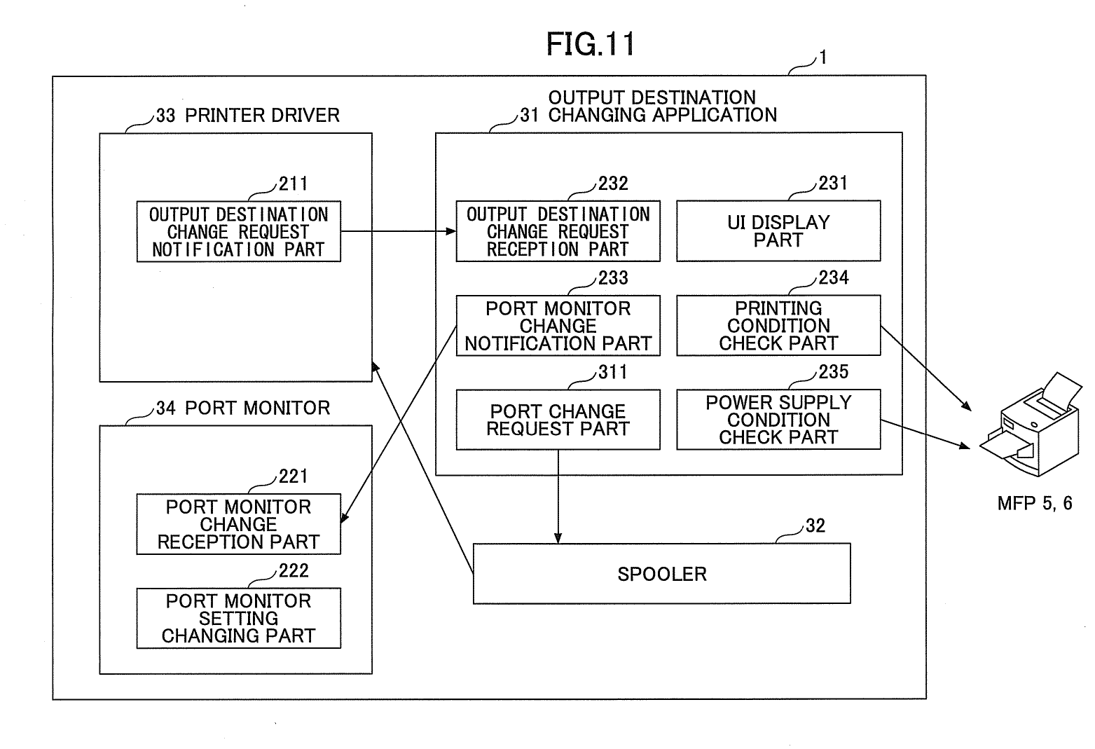

FIG. 11 is a block diagram illustrating a functional configuration of the information processor 1 according to the second embodiment.

Referring to FIG. 11 as well as FIG. 10, the information processor 1 includes the output destination changing application 31, the spooler 32, the printer driver 33, and a port monitor 34.

Next, a description is given of the output destination changing application 31. In the following description, the same elements or functions as those illustrated in FIG. 4 are referred to by the same reference numerals, and a description thereof is omitted.

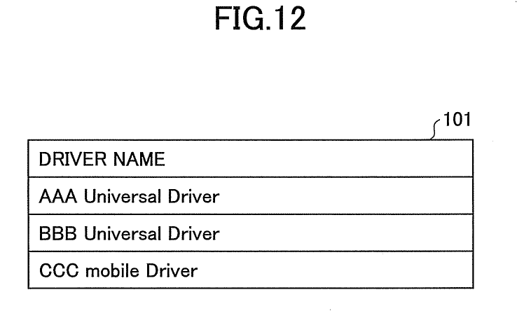

The output destination changing application 31 includes a port change request part 311. Referring to a driver list as illustrated in FIG. 12, the port change request part 311 makes a port change request to the spooler 32 (that is, requests the spooler 32 to change the port) to use the dedicated port 25 for a printer driver included in the driver list. At this point, the port change request part 311 includes the identification information of the printer driver in the port change request.

FIG. 12 illustrates a driver list 101. Referring to FIG. 12, the driver list 101 lists printer drivers that use the dedicated port 25. The driver list 101 may be retained by the port change request part 311 or be stored in an external memory. In the case illustrated in FIG. 11, it is assumed that the printer driver 33 is included in the driver list 101.

Further, the port change request part 311 determines whether to make a port change request (a request for a port change) when the output destination changing application 31 is installed and/or a new printer driver is installed. Further, the port change request part 311 may be provided outside the output destination changing application 31.

In response to receiving the port change request from the port change request part 311, the spooler 32 changes the port settings so that the dedicated port 25 is used for the printer driver 33 included in the port change request.

After the port settings are changed so that the printer driver 33 uses the dedicated port 25, the printer driver 22 transmits printing data to the dedicated port 25.

The port monitor 34 outputs the printing data transmitted from the printer driver 33 to the output destination address set for (correlated with) the dedicated port 25. Like in the first embodiment, the setting of the output destination may be changed at a desired time with the output destination changing application 31.

Next, a description is given of a port changing process according to the second embodiment. The port changing process is performed when the output changing application 31 is installed and when a new printer driver is installed.

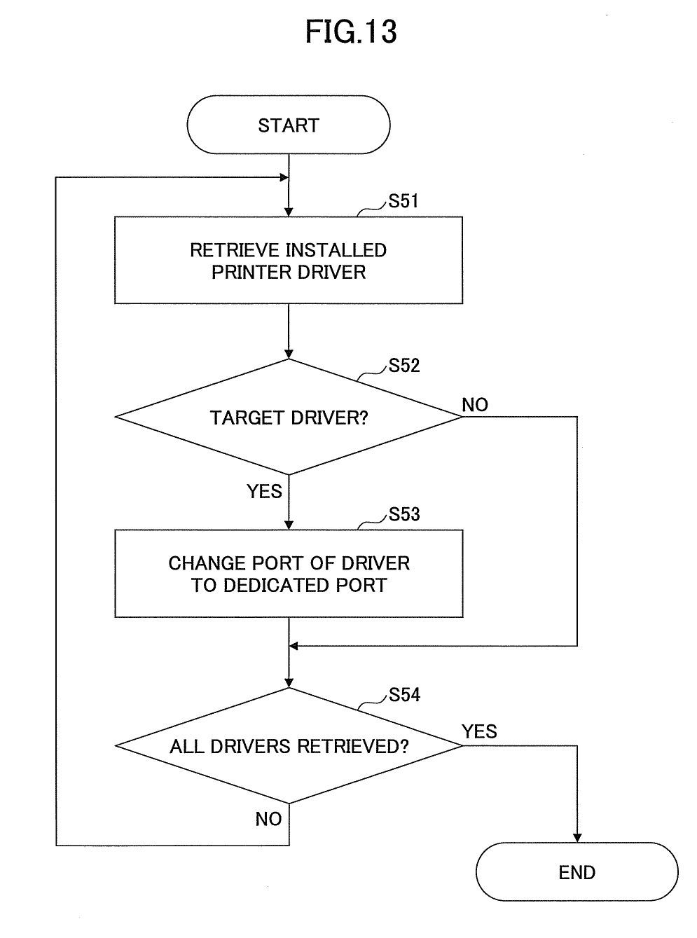

FIG. 13 is a flowchart illustrating a port changing process at the time of installation of the output destination changing application 31.

Referring to FIG. 13, in step S51, the port change request part 311 retrieves an installed printer driver.

In step S52, the port change request part 311 determines whether the retrieved printer driver is included in the driver list 101 illustrated in FIG. 12. That is, it is determined whether the retrieved printer driver is a target driver, that is, a printer driver that uses the dedicated port 25 of the output destination changing application 31 (FIG. 10). If it is determined the retrieved printer driver is a target driver (YES in step S52), the process proceeds to step S53. If it is determined that the retrieved printer driver is not a target driver (NO in step S52), the process proceeds to step S54.

In step S53, the port change request part 311 makes (transmits) a port change request including the identification information of the printer driver to the spooler 32. The spooler 32 changes the port used by the printer driver included in the port change request to the dedicated port 25.

In step S54, the port change request part 311 determines whether all of installed printer drivers have been retrieved. If all of installed printer drivers have been retrieved (YES in step S54), the port changing process ends. If all of installed printer drivers have not been retrieved (NO in step S54), the process returns to step S51.

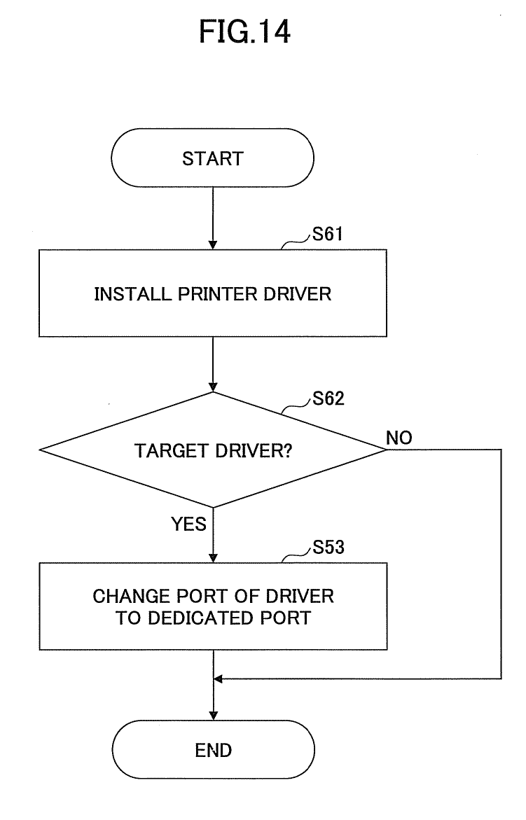

FIG. 14 is a flowchart illustrating a port changing process at the time of installation of a printer driver.

Referring to FIG. 14, in step S61, the port change request part 311 detects installation of a printer driver. Alternatively, a detection part may be provided separately to detect installation of a printer driver, and the port change request part 311 may be notified of the detection by the detection part.

In step S62, the port change request part 311 determines whether the installed printer driver is included in the driver list 101 illustrated in FIG. 12. That is, it is determined whether the installed printer driver is a target driver, that is, a printer driver that uses the dedicated port 25 of the output destination changing application 31 (FIG. 10). If it is determined that the installed printer driver is a target driver (YES in step S62), the process proceeds to step S53. If it is determined that the installed printer driver is not a target driver (NO in step S62), the port changing process ends.

Next, in step S53, the same processing as in FIG. 13 is performed, so that the dedicated port 25 is determined as the port of the installed printer driver.

Thus, according to the second embodiment, a user does not have to set the dedicated port of the output destination changing application as the port of a printer driver, and the port of the printer driver can be changed (switched) automatically to the dedicated port of the output destination changing application.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the present invention. It is also possible to configure an information processor by combining some or all of the elements of the above-described embodiments.

The present invention may be implemented by causing a computer to read a recording medium on which a program according to one aspect of the present invention is recorded. The contents of the processing described in the embodiments may be written into the program. Referring back to FIG. 1, the computer (the CPU 11) may be caused to execute this program to cause the information processor 1 to perform the above-described processing. Alternatively, this program may be recorded in the storage medium (recording medium) 18, and the computer (the CPU 11) may be caused to read the storage medium (recording medium) 18 to cause the information processor 1 to perform the above-described processing.

What is claimed is:

1. A computer-readable recording medium on which a program is recorded for causing a computer to execute a method for outputting printing data from a printer driver to an output destination, the method comprising:
displaying, while the printer driver is inactive, a change screen for changing the output destination from a first output destination preset in a communication control part by a display part of an output destination changing part;
transmitting a change notification including identification information indicating a second output destination input through the change screen to the communication control part by a notification part of the output destination changing part; and
changing the output destination from the preset first output destination to the second output destination by the communication control part in response to receiving the change notification.

2. The computer-readable recording medium as claimed in claim 1, wherein the notification part refrains from transmitting the change notification in response to printing being in process at the preset first output destination.

3. The computer-readable recording medium as claimed in claim 1, wherein the notification part refrains from transmitting the change notification in response to the second output destination being prevented from communicating.

4. The computer-readable recording medium as claimed in claim 1, wherein the display part displays the change screen in response to an instruction to change the output destination from the printer driver.

5. The computer-readable recording medium as claimed in claim 4, wherein the instruction to change the output destination is given before a printing setup screen is displayed.

6. The computer-readable recording medium as claimed in claim 4, wherein the instruction to change the output destination is given after execution of printing is requested.

7. The computer-readable recording medium as claimed in claim 1, wherein the change notification transmitted by the notification part uses an xcv command specified in Windows®.

8. The computer-readable recording medium as claimed in claim 1, wherein the method further comprises:
requesting a spooler, by a request part, to set a dedicated port of the output destination changing part as a port to be used by the printer driver, referring to a driver list in which one or more printer drivers using the output destination changing part, including said printer driver, are recorded.

9. The computer-readable recording medium as claimed in claim 8, wherein the driver list is referred to in response to at least one of installation of an application for causing the computer to implement the output destination changing part and installation of the printer driver.

10. An information processor, comprising:
a communication control part configured to output printing data from a printer driver installed in the information processor to an output destination; and
an output destination changing part,
the output destination changing part including
a display part configured to display, while the printer driver is inactive, a change screen for changing the output destination from a first output destination preset in the communication control part; and
a notification part configured to transmit a change notification including identification information indicating a second output destination input through the change screen to the communication control part,
wherein the communication control part is configured to change the output destination from the preset first output destination to the second output destination in response to receiving the change notification from the notification part.

11. The information processor as claimed in claim 10, wherein the notification part is configured to refrain from transmitting the change notification in response to printing being in process at the preset first output destination.

12. The information processor as claimed in claim 10, wherein the notification part is configured to refrain from transmitting the change notification in response to the second output destination being prevented from communicating.

13. The information processor as claimed in claim 10, wherein the display part is configured to display the change screen in response to an instruction to change the output destination from the printer driver.

14. The information processor as claimed in claim 13, wherein the instruction to change the output destination is given before a printing setup screen is displayed.

15. The information processor as claimed in claim 13, wherein the instruction to change the output destination is given after execution of printing is requested.

16. The information processor as claimed in claim 10, wherein the change notification transmitted by the notification part uses an xcv command specified in Windows®.

17. The information processor as claimed in claim 10, further comprising:
a request part configured to request a spooler to set a dedicated port of the output destination changing part as a port to be used by the printer driver, referring to a driver list in which one or more printer drivers using the output destination changing part, including said printer driver, are recorded.

18. The information processor as claimed in claim 17, wherein the request part is configured to refer to the driver list in response to at least one of installation of an application for causing the information processor to implement the output destination changing part and installation of the printer driver.
